(19) United States
(12) Patent Application Publication
(10) Pub. No.: US 2024/0288120 A1
(43) Pub. Date: Aug. 29, 2024

(54) TANK FOR PRESSURIZED GAS

(71) Applicant: Faurecia Hydrogen Solutions France, NANTERRE (FR)

(72) Inventor: Marc FARAUT, MONTBELIARD (FR)

(21) Appl. No.: 18/584,288

(22) Filed: Feb. 22, 2024

(30) Foreign Application Priority Data
Feb. 24, 2023 (FR) 23 01711

(51) Int. Cl. F17C 1/00

(52) U.S. Cl. CPC F17C 1/00; F17C 2201/0104; F17C 2203/0619; F17C 2203/0646; F17C 2203/066; F17C 2203/0673; F17C 2209/2127; F17C 2209/221; F17C 2221/012

(57) ABSTRACT

A tank for pressurized gas, such as hydrogen, comprises a metal base substantially of revolution about an axis and a shell. The metal base comprises a substantially cylindrical groove recessed along the axis. The shell comprises a substantially cylindrical neck plumb along the axis, with a diameter substantially identical to a diameter of the groove. The groove receives a ring made of plastic material and the neck is assembled with the ring.

### CROSS-REFERENCE TO RELATED APPLICATION

This application is a U.S. non-provisional application claiming the benefit of French Application No. 23 01711, filed on Feb. 24, 2023, which is incorporated herein by reference in its entirety.

### TECHNICAL FIELD

The disclosure relates to a tank for pressurized gas, such as hydrogen. More particularly, the disclosure aims to protect an embodiment of the sealed interface between the base and the shell or liner.

### BACKGROUND

A pressurized gas tank can be produced from a structure made of composite material (fiber reinforcement embedded in a resin matrix) of typically cylindrical shape in the central part, ending at both ends by a hemispherical cap.

In order to be able to fill the gas tank and then draw the gas, the structure typically comprises a through-hole, along an axis, conventionally arranged at the center of a hemispherical cap. A generally metallic base is arranged in this hole, which base is substantially of revolution around a through-hole along said axis, arranged substantially aligned with the hole so as to allow filling and/or drawing.

The structure made of composite material is not intrinsically gas-tight. Thus, its inner surface is lined with a shell, conventionally made of elastomeric material, ensuring the gas-tightness. The shape of this shell substantially reproduces the inner shape of the structure.

The base has a substantially cylindrical groove along said axis. The shell has a neck which is able to interface with the base, coaxially around the bore. This interface should be gas-tight.

In order to guarantee the attachment and gas-tightness, at the interface between the shell and the base, several embodiments are known. According to a first embodiment, the neck is inserted into the groove and bonded. However, bonding is a complicated process that is difficult to control and requires a very significant drying time, which can reach 8 hours per tank. According to another embodiment, an additional part clamps the neck into the groove so as to hold it in the groove, the tightness being provided by the clamping. This approach requires an additional part, and is tricky to implement.

Thus, another approach is sought for producing a sealed assembly between the neck of the shell and the base.

### SUMMARY

The disclosure proposes to proceed in two stages: in a first stage, a ring made of plastic material is placed and attached in a groove, and in a second stage a neck of the shell is assembled with this ring.

The disclosure relates to a tank for pressurized gas, such as hydrogen, comprising a metal base substantially of revolution about an axis, the metal base comprising a substantially cylindrical groove recessed along the axis, and a shell comprising a substantially cylindrical neck plumb along the axis, with a diameter substantially identical to a diameter of the groove, where the groove receives a ring made of plastic material and in that the neck is assembled with the ring.

Particular features or embodiments, usable alone or in combination, are:
the ring is made and placed in the groove by overmolding,
the ring is made of polyamide or any other thermoplastic material,
the ring occupies a bottom of the groove,
the ring protrudes from the groove, preferentially on a flat surface of the base, so as to have an interface surface which is increased relative to a width of the groove,
the groove has a depth to width ratio greater than 1, preferentially greater than 3, even more preferentially greater than 5,
the surface of the groove is prepared for overmolding by depositing a bonding primer or by overmolding a thin layer of plastic,
the surface of the groove is prepared for overmolding by plasma treatment,
the neck is assembled with the ring by welding, preferentially done by infrared or hot gas, even more preferentially done by rotary friction.

According to a second aspect of the disclosure, a method for producing such a tank comprises the following steps:
making and placing the ring in the groove of the base by overmolding,
assembling the shell by welding its neck to the ring.

### BRIEF DESCRIPTION OF THE DRAWINGS

The disclosure will be better understood on reading the following description, given solely by way of example, and with reference to the appended figures wherein:

FIG. 1 shows, in a cross sectional axial view, a tank according to a first embodiment, and

FIG. 2 shows, in a cross sectional axial view, a tank according to another embodiment.

### DETAILED DESCRIPTION

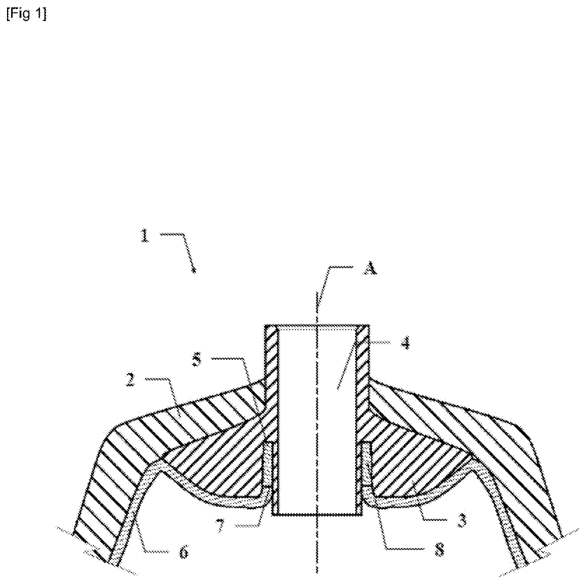

Referring to FIG. 1, the disclosure relates to a tank 1 for pressurized gas. The gas may, for example, be hydrogen. The pressure may be increased typically up to 700 bar.

Such a tank 1 comprises a structure 2. This structure is typically made of composite material, comprising a reinforcement made of fibers, typically glass or carbon fibers, embedded in a plastic resin matrix. This structure 2, for example, takes the shape of a cylinder terminating at both ends by hemispherical caps. The structure 2 is conventionally pierced by an opening, in order to allow filling and/or drawing, advantageously arranged at the center of a hemispherical cap. The tank 1 further comprises a base 3, most often metal, advantageously made of aluminum, substantially of revolution about an axis A. The base 3 is arranged in said opening. The base 3 is advantageously pierced with a bore 4 of axis A. It comprises a groove 5 substantially in the form of a hollow cylinder of axis A. The tank 1 further comprises a shell 6, of shape adapted to follow the inner wall of the structure 2 and comprising a neck 7 substantially in the form of a solid cylinder of axis A. The neck 7 is placed opposite the groove 5 of the base 3 and has a diameter substantially identical to the diameter of the groove 5 or of a ring 8.

According to one feature of the disclosure, the ring 8 is arranged in the groove 5. The ring 8 is made of plastic and is secured to the metal of the base 3.

The fastening between the plastic ring 8 and the metal groove 5 can be done by any method. It is thus conceivable to forcibly compress the ring 8 in the groove 5. It is also possible, additionally or alternatively, to bond the ring 8 into the groove 5.

According to another preferred feature, the ring 8 is made and placed by injection molding into the groove 5, which is also called overmolding. The base 3 is placed in a mold and the plastic of the ring 8 is injected by molding into the groove 5.

According to another feature, the plastic material of the ring 8 is polyamide. Alternatively, this plastic material may also be any thermoplastic material.

According to another feature, more particularly shown in FIG. 1, the ring 8 is shaped to occupy the bottom of the groove 5.

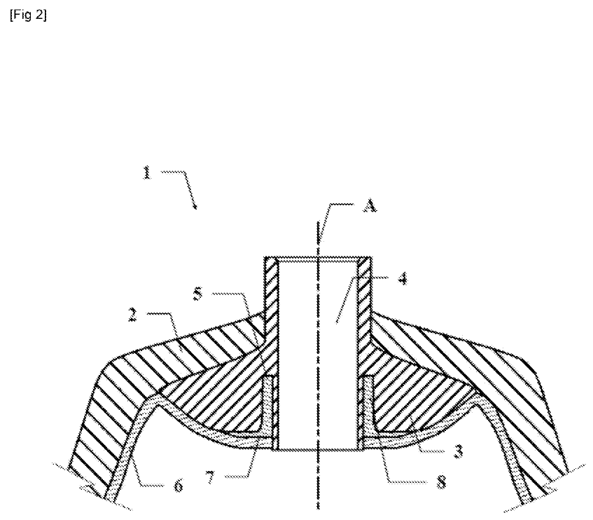

According to another feature, more particularly shown in FIG. 2, the ring 8 is shaped to occupy the bottom of the groove 5 and also to protrude outside the groove 5. Preferentially, the ring 8 protrudes outside the groove 5, advantageously on a flat surface of the base 3 bordering the groove 5 and substantially perpendicular to the axis A. According to such an embodiment, the ring 8 has an augmented interface surface, much wider than the width of the groove 5. This feature advantageously makes it possible to increase the possible interface area with the neck 7 of the shell 6. This also makes it possible to accommodate dimensional variations of said neck 7. These dimensional variations may, for example, be variations in the mesh thickness of the neck 7 or else a lack of circularity of the neck 7 or else a lack of coaxiality of the neck 7 with the axis A.

In relation to the embodiment of the shell 6 by blow molding, this dimensional accommodation tolerance is advantageous in that this embodiment by blow molding can create this type of dimensional deviation.

According to another advantageous feature, the groove 5 has a depth to width ratio greater than 1, preferentially greater than 3, even more preferentially greater than 5. This feature contributes to improving the attachment of the ring 8 to the groove 5 by adhesion.

According to another feature, the adhesion of the plastic material of the ring 8 to the metal surface of the base 3 is greatly improved by a preparation of the metal surface of the base 3 prior to the overmolding. This preparation can be carried out by depositing a bonding primer.

According to one feature, the bonding primer is a thermosetting or thermoplastic resin.

Alternatively, the preparation of the metal surface of the base 3 may comprise overmolding a thin layer of plastic. The term “thin layer” is used herein to mean a layer having a thickness of less than 1 mm.

This overmolding can be carried out by a particular plastic in that it has improved adhesion with the metal surface. This plastic can also be the same as the plastic of the ring in order to improve the strength of the overmolding of the ring 8.

Alternatively or additionally, this preparation can be carried out by a plasma treatment which performs a surface modification of the surface condition, promoting the subsequent attachment of the bonding primer or of the overmolded plastic material directly.

It is also possible to geometrically modify the surface of the base 3 in line with the surfaces in contact with the ring 8. This may comprise machining the surfaces, so as to create a texturing, a relief, such as knurling, scratches and/or micro-grooves. This aims to increase the fastening of the plastic material of the ring 8.

According to another feature of the disclosure, the neck 7 of the shell 6 is then assembled with the ring 8 by welding. Said welding is preferentially carried out by infrared or hot gas. This allows heating of one, the other or both parts to produce surface melting. The two parts are then pressed against one another, performing the welding.

Preferentially, the ring 8 and the neck 7 of the shell 6 are made of the same plastic material in order to improve the strength and robustness of the assembly by welding.

According to a preferred embodiment, this welding is carried out by rotary friction. In the embodiment, one, the other or both parts to be assembled are brought into relative movement and pressed against one another. No prior heating is necessary. The relative movement creates friction during the pressing, which creates heat and thereby produces melting of the parts at their interface, allowing welding. In the present case, the relative movement is advantageously a rotation about the axis A. Preferentially, the base 3 is rotated relative to a fixed shell 6.

According to another feature, the shell 6 is produced by blow molding, prior to the welding. This embodiment is advantageous in that it allows faster and therefore less expensive production. One drawback of this embodiment is a larger dimensional dispersion. However, as described above, this dispersion is easily accommodated by the subsequent assembly by welding. This is true in the embodiment of FIG. 1. This is all the more true in the embodiment of FIG. 2, where the receiving surface of the ring 8 is increased.

The disclosure also relates to a method for producing such a tank 1. This method comprises the following steps. During a first step, the ring 8 is made and placed in the groove 5, preferentially by overmolding. During a subsequent step, the shell 6 is assembled by welding its neck 7 with the ring 8.

The disclosure has been illustrated and described in detail in the drawings and the preceding description. This must be considered as illustrative and given by way of example and not as limiting the disclosure to this only description. Many alternative embodiments are possible.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

### LIST OF REFERENCE SIGNS

1: tank
2: structure,
3: base,
4: bore,
5: groove,
6: shell,
7: neck,
8: ring,
A: axis,

1. A tank for pressurized gas, such as hydrogen, comprising:
a metal base substantially of revolution about an axis, the metal base comprising a substantially cylindrical groove recessed along the axis; and
a shell comprising a substantially cylindrical neck plumb along the axis, the shell having a diameter substantially identical to a diameter of the cylindrical groove, wherein the cylindrical groove receives a ring made of plastic material and in that the cylindrical neck is assembled with the ring.

2. The tank according to claim 1, wherein the ring is at least partially received in the cylindrical groove with an overmolding interface.

3. The tank according to claim 1, wherein the ring is made of a thermoplastic material.

4. The tank according to claim 1, wherein the ring is made of polyamide.

5. The tank according to claim 1, wherein the ring occupies a bottom of the cylindrical groove.

6. The tank according to claim 1, wherein the ring protrudes from the cylindrical groove, on a flat surface of the metal base, so as to have an interface surface which is increased relative to a width of the cylindrical groove.

7. The tank according to claim 1, wherein the cylindrical groove has a depth to width ratio greater than 1.

8. The tank according to claim 1, wherein the cylindrical groove has a depth to width ratio greater than 3.

9. The tank according to claim 1, wherein the cylindrical groove has a depth to width ratio greater than 5.

10. The tank according to claim 1, wherein a surface of the cylindrical groove includes a bonding primer.

11. The tank according to claim 1, wherein a surface of the cylindrical groove includes an overmolded thin layer of plastic.

12. The tank according to claim 1, wherein a surface of the cylindrical groove comprises a plasma treatment overmolding.

13. The tank according to claim 1, wherein the cylindrical neck and the ring are assembled at a weld interface.

14. The tank according to claim 13, wherein the weld interface comprises an infrared weld interface.

15. The tank according to claim 13, wherein the weld interface comprises a hot gas weld interface.

16. The tank according to claim 13, wherein the weld interface comprises a rotary friction weld interface.

17. A method for manufacturing a tank according to claim 1, comprising the following steps:
making and placing the ring at least partially in the cylindrical groove of the metal base by overmolding; and
assembling the shell by welding the cylindrical neck to the ring.
